(19) United States
(12) Patent Application Publication
(10) Pub. No.: US 2014/0337006 A1
(43) Pub. Date: Nov. 13, 2014

(54) METHOD, SYSTEM, AND MOBILE TERMINAL FOR REALIZING LANGUAGE INTERPRETATION IN A BROWSER

(71) Applicant: Tencent Technology (Shenzhen) Co., Ltd., Shenzhen (CN)

(72) Inventor: Yongfei MA, Shenzhen (CN)

(73) Assignee: Tencent Technology (Shenzhen) Co., Ltd., Shenzhen (CN)

(21) Appl. No.: 14/285,081

(22) Filed: May 22, 2014

Related U.S. Application Data
(63) Continuation of application No. PCT/CN2013/089584, filed on Dec. 16, 2013.

(30) Foreign Application Priority Data
May 13, 2013 (CN) 2013101741938

(51) Int. Cl. G09B 19/06; G10L 21/06; G10L 15/26; G06F 17/28

(52) U.S. Cl. CPC G09B 19/06; G06F 17/289; G10L 21/06; G10L 15/26
USPC 704/2

(57) ABSTRACT

Described are a method, system and mobile terminal for realizing language interpretation through a browser, which may improve the efficiency for learning a foreign language or enable a user to interact in real time through a voice format, with another person who speaks the foreign language. The method includes the steps of receiving through a user's terminal browser language interpretation interface, expression information of an input language; translating the expression information of the input language into expression information of a target language, according to an input predetermined conversion relation between the input language and the target language; outputting the expression information of the target language through a text format; and outputting the expression information of the target language through a voice format.

### CROSS-REFERENCE TO RELATED APPLICATIONS

This application is a continuation of PCT Application No. PCT/CN2013/089584, filed on Dec. 16, 2013, which claims priority to Chinese Patent Application No. 2013101741938, filed on May 13, 2013, which is incorporated by reference in their entireties.

### FIELD OF THE TECHNOLOGY

The present disclosure relates to the technical field of the Internet, and particularly to a method, a system and a mobile terminal for realizing a language interpretation through a browser of a mobile terminal.

### BACKGROUND

Mobile phone's browser may help a user to learn a foreign language. For example, a foreign language translation may be looked up by inputting in text information an input language, a translated text of a target language (such as Chinese→English or vice versa) may then be displayed.

However, in practice, it may be difficult for someone who is not familiar with the target language to utter correctly the pronunciation of the translated content. In this regard, user's learning efficiency and real time language translation experience may be negatively impacted.

### SUMMARY

The embodiments of the present disclosure disclose a method, a system and a mobile terminal for realizing a language interpretation through a terminal browser, and the present disclosure may improve the efficiency of learning a foreign language or enable a user to interact in real time through a voice format with another person who speaks the foreign language.

In an aspect, the embodiments of the present disclosure disclose a method for realizing language interpretation through a browser. The method may include: receiving through a user's terminal browser language interpretation interface, expression information of an input language; translating the expression information of the input language into expression information of a target language, according to an input predetermined conversion relation between the input language and the target language; outputting the expression information of the target language through a text format; and outputting the expression information of the target language through a voice format.

In another aspect, the embodiments of the present disclosure disclose a system for realizing language interpretation through a browser, and the system may include: at least a processor operating in conjunction with at least a memory which stores instruction codes operable as plurality of units, wherein the plurality of units may include: a first receiving unit which receives through a user's terminal browser language interpretation interface, expression information of an input language; a translating unit which translates the expression information of the input language into expression information of a target language, according to an input predetermined conversion relation between the input language and the target language; a first outputting unit which outputs the expression information of the target language through a text format; and a second outputting unit which outputs the expression information of the target language through a voice format.

In another aspect, the embodiments of the present disclosure disclose a mobile terminal being the system.

Yet in another aspect, the embodiments of the present disclosure disclose a non-transitory computer-readable medium having stored thereon, a computer program having at least one code section being executable by a machine for causing the machine to perform functions, including: receiving through a user's terminal browser language interpretation interface, expression information of an input language; translating the expression information of the input language into expression information of a target language, according to an input predetermined conversion relation between the input language and the target language; outputting the expression information of the target language through a text format; and outputting the expression information of the target language through a voice format.

Through the implementation of the embodiments of the present disclosure, a user who may not be too familiar with a target foreign language may be enabled to quickly read out the translated information with auxiliary support from the information, which may be outputted in a text format or voice format. In addition, the translated text or voice in the target language may be stored or stored as an auxiliary support for future retrieval to be played or displayed repeatedly as a learning tool. Thus, effectively improve the efficiency of learning the target foreign language, or enhance the experience of interacting in real time with someone who speaks the target foreign language.

### BRIEF DESCRIPTION OF THE DRAWINGS

The accompanying drawings are included to provide a further understanding of the claims and disclosure, are incorporated in, and constitute a part of this specification. The detailed description and illustrated embodiments described serve to explain the principles defined by the claims and may not be construed in a limited sense.

FIG. 1 illustrates an exemplary flow diagram of a method for realizing a language interpretation in a browser, according to an embodiment of the disclosure.

FIG. 2 illustrates an exemplary flow diagram of a method for realizing a language interpretation in a browser, according to another embodiment of the disclosure.

FIG. 3 depicts an exemplary plug-in interface to a browser of a mobile terminal, according to an embodiment of the disclosure.

FIG. 4 depicts an exemplary language interpretation interface to a browser of a mobile terminal, according to an embodiment of the disclosure.

FIG. 5 depicts an exemplary language interpretation interface to a browser of a mobile terminal, at which a user conducts operation of the language interpretation interface, as shown in FIG. 4, in the browser to trigger and set a voice output volume level, according to an embodiment of the disclosure.

FIG. 6 depicts an exemplary language interpretation interface to a browser of a mobile terminal, at which a user conducts operation of the language interpretation interface, as shown in FIG. 4, in the browser to trigger and set a conversion relation between an input language and a target language, according to an embodiment of the disclosure.

FIG. 7 depicts an exemplary language interpretation interface to a browser of a mobile terminal, at which information expressed in a target language is output at the language interpretation interface in the browser, are disclosed in the embodiments of the present disclosure, according to an embodiment of the disclosure.

FIG. 8 depicts an exemplary language interpretation interface to a browser of a mobile terminal, which is disclosed in the embodiments of the present disclosure, according to another embodiment of the disclosure.

FIG. 9A illustrates an exemplary structural diagram of a system or mobile terminal which performs a language interpretation in a browser, according to an embodiment of the disclosure.

FIG. 9B illustrates an exemplary structural diagram of the translating unit of FIG. 9A, according to another embodiment of the disclosure.

### DETAILED DESCRIPTION OF THE EMBODIMENTS

The various embodiments of the present disclosure are further described in details in combination with attached drawings and embodiments below. It should be understood that the specific embodiments described here are used only to explain the present disclosure, and are not used to limit the present disclosure. In addition, for the sake of keeping description brief and concise, the newly added features, or features that are different from those previously described in each new embodiment will be described in details. Similar features will be referenced back to the prior descriptions. Some features may be referenced to other drawings to be described.

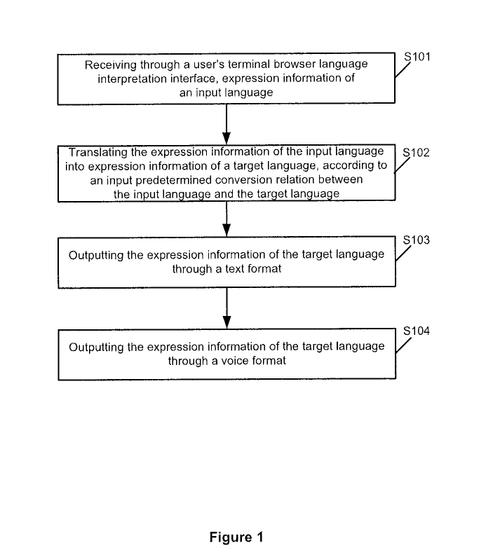

FIG. 1 illustrates an exemplary flow diagram of a method for realizing a language interpretation in a browser, according to an embodiment of the disclosure. The method may include the following exemplary steps:

In Step S101: Receiving through a user's terminal browser language interpretation interface, expression information of an input language. The language is the language to be translated from, which may be expressed and input to the language interpretation interface into the browser in the form of either voice format or text characters format.

In Step S102: Translating the expression information of the input language into expression information of a target language, according to an input predetermined conversion relation between the input language and the target language. The target language is the output language after the translation operations. A preset conversion relation may be set between the input language and the target language.

For another example, it may be assumed that in step S101, the expression information input by the user through the language interpretation interface in the browser is English (i.e., the input language), and a conversion relation (i.e., English→Arabic) is preset between English language and the Arabic language (i.e., the target language). In other words, the information expressed in English (i.e., the input language) may be translated into the information which is expressed in Arabic (i.e., the target language), according to the preset conversion relation (i.e., English→Arabic).

In another example, it may be assumed that in step S101, the information that has been input by the user through the language interpretation interface in the browser is expressed in German (i.e., the input language), and a conversion relation (i.e., German→Chinese) has been preset between German and Chinese (i.e., the target language) is preset between German and Chinese. In other words, the information expressed in German (i.e., the input language) may be translated into the information which is expressed in Chinese (i.e., the target language), according to the preset conversion relation (i.e., German→Chinese).

In Step S103: outputting the information, which may be expressed in the target language, which the output after the translation is in the form of text characters. In the embodiments of the present disclosure, it may be feasible to output the information, which is expressed in the target language in the form of text characters at the language interpretation interface in the browser, or it may be feasible to pop out a display interface independent of the language interpretation interface in the browser and to output the information, which is expressed in the target language, in the form of text characters at this display interface.

In Step S104: Outputting the expression information of the target language through a voice format. In the embodiments of the present disclosure, the execution order of step S103 and step S104 may be switched or reversed, or alternately, both steps 103 and 104 may also be executed at the same time; the embodiments of the present disclosure do not set any limit.

In the embodiments of the present disclosure, the information that has been output in voice format and expressed in the target language may also be stored. In the method, as disclosed in FIG. 1, after having received the information which has been input by the user through the language interpretation interface in the browser and is expressed in an input language, it is feasible to translate the input language into the information to be expressed in a target language in the form of text characters and in voice format at the same time.

Accordingly, a user who is not very familiar with the target language may be able to quickly read out the translated information with an auxiliary support of voice through the user's browser. In addition, the user may rely on the displayed text characters and listen to the stored voice format of the target language to repeatedly sound out the sentence with proper pronunciation to improve the efficiency of learning a foreign language.

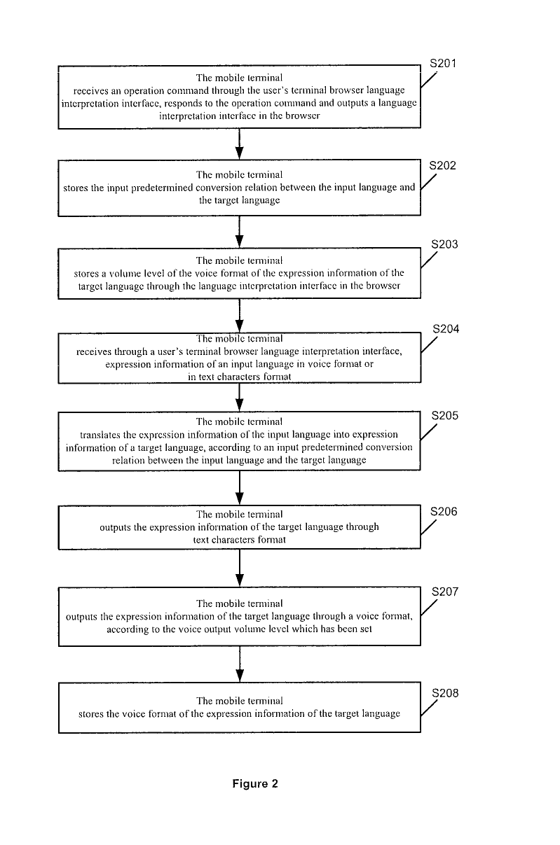

FIG. 2 illustrates an exemplary flow diagram of a method for realizing a language interpretation in a browser, according to another embodiment of the disclosure. The method described may be performed in a mobile terminal, such as smart phones (such as Android mobile phones and iOS mobile phones), tablets, laptop computers, notebook computers, desk top personal computers (PCs) and other mobile Internet devices (MID).

For convenience of descriptions for the steps in FIG. 2, reference designations from other figures may be referred to. The method may include the following exemplary steps:

In step S201: The mobile terminal receives an operation command through the user's terminal browser language interpretation interface, and responds to the operation command and outputs a language interpretation interface in the browser.

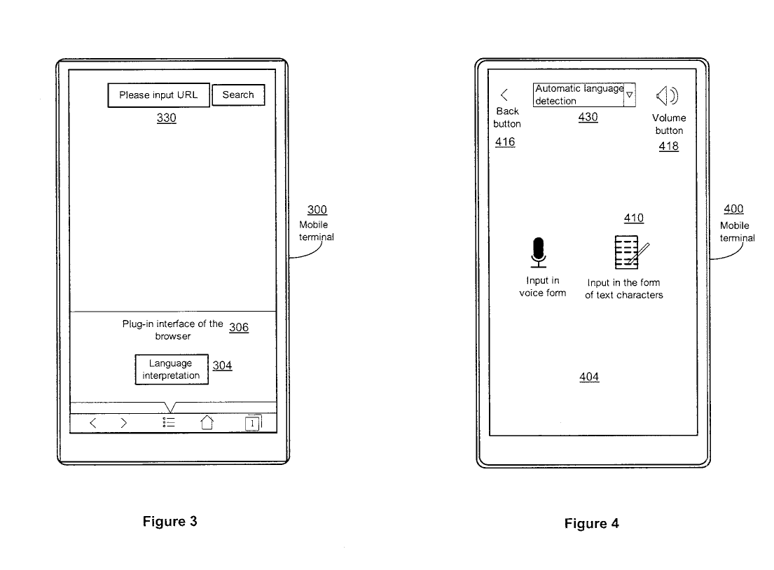

More specifically, a language interpretation plug-in (306) may be added into a language interpretation interface (304) of a browser (330) of a user's terminal (300) as shown in FIG. 3. To invoke the functions of the language interpretation plug-in (306), a user may touch (alternately single click or double click) an icon of the language interpretation plug-in (306) on the browser (330). An operation command may be inputted by the user. The mobile terminal (300) may respond to the operation command to output through the language interpretation plug-in (306) to the browser (330), the language interpretation interface (304) (as shown in FIG. 3).

FIG. 4 depicts an exemplary language interpretation interface to a browser (430) of a mobile terminal (400). The language interpretation interface (404) may include a back button (416) function, when touched or triggered may return the user to the plug-in interface of the browser (306) (as shown in FIG. 3). The language interpretation interface (404) may include a browser (430) which may provide an automatic language detection function with conversion relation setting between an input language and a target language for language interpretation. In addition, the language interpretation interface (404) may include a volume button (418) function which sets a voice output volume level, an identifier icon (420) to be triggered to receive an input language in voice format and an identifier icon (410) to be triggered to receive an input language in text characters format.

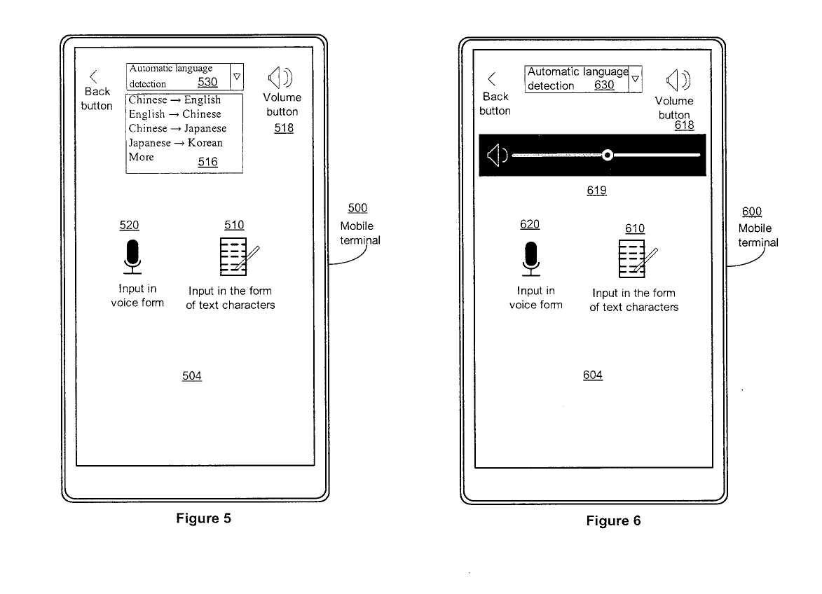

Step S202: The embodiment of this step may be illustrated in FIG. 5. The mobile terminal (500) stores an input predetermined conversion relation (516) between the input language and the target language. The browser (530) of the mobile terminal (500) may display an automatic language detection entry operation from the language interpretation interface (504). The browser (530) may show that various conversion relation between different input languages (e.g., Chinese, English, Japanese, German . . . ) and various target languages (English, Chinese, Japanese, Korean . . . ).

The mobile terminal (500) may store the conversion relation (516) between the input language and the target language, for example: Chinese→English, English→Chinese, Chinese→Japanese, Japanese→Korean, etc. into a memory of the mobile terminal (500). Alternately, the conversion relation (516) may be an on-line feature, which a user may retrieve through a network connection from a website using the browser (530) to invoke the language interpretation functions as described in the disclosed method of FIG. 2.

Step S203: The embodiment of this step may be illustrated in FIG. 6. The mobile terminal (600) may store a voice output volume level (619) which has been set by the user through the language interpretation interface (604) in the browser. The user may operate the volume button (615) at the language interpretation interface (604), as shown in FIG. 6, so as to set the voice output volume level (619). The mobile terminal (600) may store the voice output volume level (619) which may be set by the user.

In the embodiments of the present disclosure, the execution order of the abovementioned step S202 and step S203 may be switched; the embodiments of the present disclosure do not set any limit.

Step S204: The mobile terminal may receive through a user's terminal browser language interpretation interface (604), expression information of an input language in voice format (620) or in text characters format (610).

In the embodiments of the present disclosure, the user may click the identifier, which is set at the language interpretation interface, as shown in FIG. 6, in the browser and configured to trigger an expression of input language in voice form (620) or an expression of input language in text characters format (610).

Step S205: The mobile terminal may translate the expression information of the input language into expression information of a target language, according to an input predetermined conversion relation between the input language and the target language.

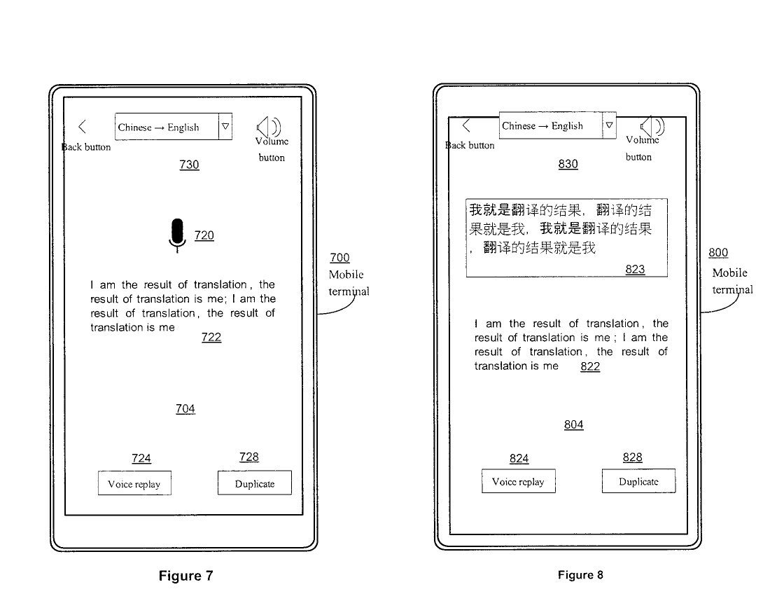

Step S206: The embodiment of this step may be illustrated in FIGS. 6-8. The mobile terminal may output the expression information of the target language through text characters format. It may be assumed that the user conducts operation of automatic detection language entry at the language interpretation interface in the browser (704, 804) to set the conversion relation (730, 830) between the input language and the target language as Chinese→English; furthermore, the user may click the identifier (620 or 610), which is set at the language interpretation interface (604), as shown in FIGS. 6-8.

If the input language is to be expressed in voice format, identifier (620) may be triggered. If the input language is to be expressed in text characters format, identifier (610) may be triggered. For example, it is decided that the conversion relation (730, 830) for the input language is Chinese and the target language is English, the following Chinese language expression “ [symbol] , [symbol] , [symbol] , [symbol] [symbol] ” spoken in voice format may be translated into the English language with the following expression [“I am the result of translation, the result of translation is me; I am the result of translation, the result of translation is me”]. The output of the translated English expression both in text characters format (722, 822) and in voice format (720) in the language interpretation interface (704) browser.

Alternately, if the input format is text characters, the following Chinese language expression “ [symbol] , [symbol] , [symbol] , [symbol] [symbol] ” written in text format (823) may be translated into the English language with the following expression [“I am the result of translation, the result of translation is me; I am the result of translation, the result of translation is me”]. The output of the translated English expression both in text characters format (722, 822) and in voice format (720) in the language interpretation interface (704) browser.

Step S207: The mobile terminal may output the expression information of the target language through a voice format, according to the voice output volume level which has been set. As discussed in FIG. 6, the mobile terminal (600) may output the target language in English in voice format according to a setting of voice output volume level (619) to read out audibly “I am the result of translation, the result of translation is me; I am the result of translation, the result of translation is me” a single time, or repeatedly.

Step S208: The mobile terminal may store the voice format of the expression information of the target language. The mobile terminal may store the result of the language translation, both in voice format and in text characters format for archiving and for display or replay at a later time, through an internal memory (e.g., DRAM) or through a removable memory card (Flash).

In the above embodiments, step S206 and step S207 may be executed in the same order or in reversed order, or executed simultaneously to display the outputs in text characters format and to read out audibly the target language in voice format.

In the embodiments of the present disclosure, the mobile terminal may further respond to the translation result with a duplicating instruction (728, 828) to make multiple files of the text characters of the translated text and multiple voice files to repeat the voice output multiple times.

In the embodiments of the present disclosure, the mobile terminal may further respond to a voice replaying instruction (724, 824), which may replay the voice file of the target language for learning purpose or for repeating the line for the listener.

It may be seen that in the above embodiments, the same terminal implementing the method may be useful to perform translation in both directions. For example, a Chinese speaker may converse with an English speaker by setting the conversion relation to English→Chinese and Chinese→English detection. That way, mobile terminal may translate the English spoken sentence in voice format into Chinese voice format and in text characters as auxiliary information. Likewise, the Chinese speaker may reply with Chinese in voice format, and the mobile terminal may translate the Chinese spoken sentence in voice format and text format as auxiliary information back to English for the English speaker.

Alternately, the English speaker may use his mobile terminal and set the conversion relation to Chinese→English only, and the Chinese speaker may use his mobile terminal and set his the conversion relation to English→Chinese only for detection.

Yet in another embodiment, the translated language (in text characters or voice format) may further be used to be translated into a second target language (such as Arabic) to enable a non-Chinese and non-English speaker to understand the translated content. Of course, the Arabic speaker may simply set his mobile terminal device to convert Chinese→Arabic, and English→Arabic in joining a conversation with both the Chinese speaker and English speaker.

In brief, the above disclosure provides an efficient way for any party to almost instantly be able to understand a foreign spoken language in his own native language, and speak his own native language to be translated into a foreign language through the use of a mobile device implementing this method, thus closing the gap of communication of speaking in different tongues.

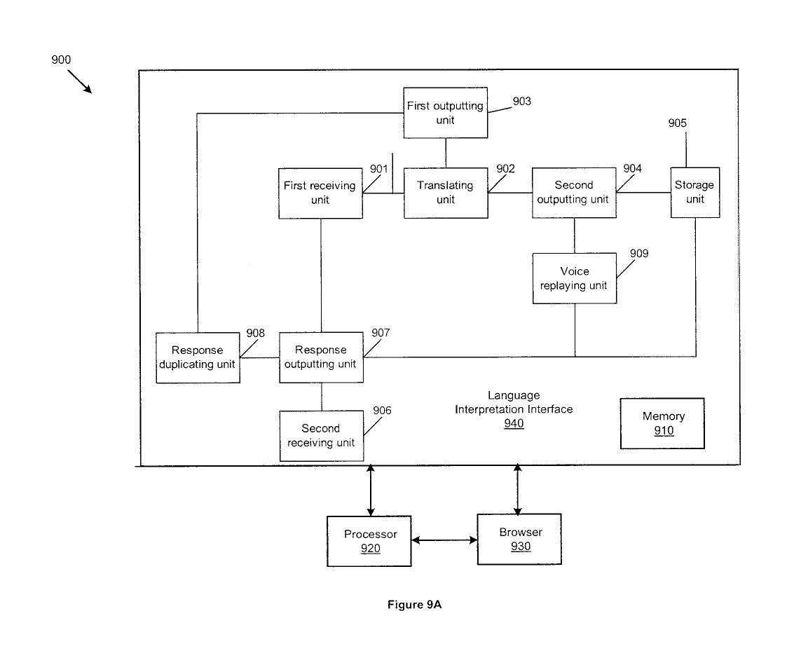

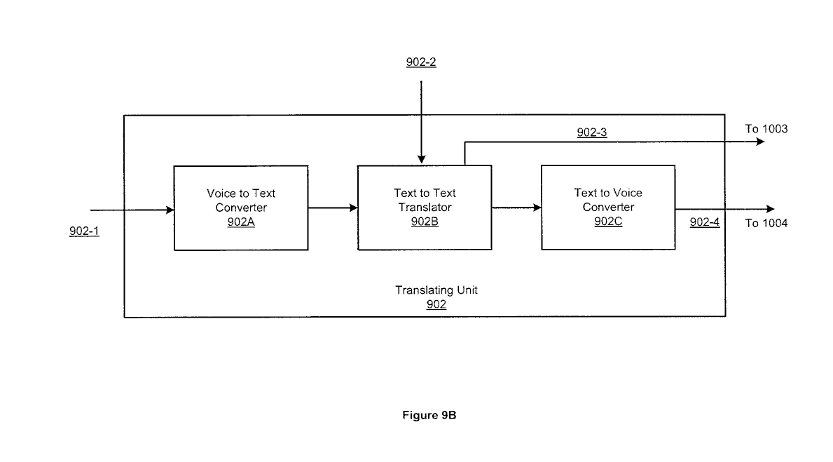

FIG. 9 illustrates an exemplary structural diagram of a system (900) or a mobile terminal which performs language interpretation in a browser (930), according to an embodiment of the disclosure. The system (900) as shown in FIG. 9 may be applicable to all kinds of mobile terminals (as shown in FIGS. 3-8), such as a smart phone (such as an Android mobile phones and an iOS mobile phones), a tablet PCs and other MIDs. The system may include: at least a processor (920) operating in conjunction with at least a memory (910) which stores instruction codes operable as a plurality of units, the plurality of units include:

A first receiving unit (901) which receives through a user's terminal browser language interpretation interface, expression information of an input language;

A translating (902) which translates the expression information of the input language into expression information of a target language, according to an input predetermined conversion relation between the input language and the target language.

A first outputting unit (903) which outputs the expression information of the target language through a text format.

A second outputting unit (904) which outputs the expression information of the target language through a voice format.

In an embodiment, the system (900) may further include a storage unit (905), which stores the voice format of the expression information of the target language.

The first receiving unit (901) receives through the voice format, the expression information of the input language through the user's terminal browser language interpretation interface; or the first receiving unit receives through the text format, the expression information of the input language through the user's terminal browser language interpretation interface.

In an embodiment, the system (900) may further include:

A second receiving unit (906) which receives an operation command through the user's terminal browser language interpretation interface.

A response outputting unit (907) which responds to the operation command and outputs the language interpretation interface in the browser.

The storage unit (905) may store the input predetermined conversion relation between the input language and the target language which has been outputted by the response outputting unit (907) in the browser between the input language and the target language; and stores a volume level of the voice format of the expression information of the target language through the language interpretation interface in the browser.

In the embodiments of the present disclosure, the specific mode whereby the second outputting unit (904) outputs the information expressed in the target language, in voice form by outputting the expression information of the target language through a voice format according to a volume level which is stored in the storage unit (905).

The system (900) may further include: a response duplicating unit (908) which in response to receiving a translation duplication command input through the language interpretation interface which has been outputted by the response outputting unit (907) on the user terminal's browser, carries out the translation duplication of the expression information to be output by the first outputting unit (903), the target language through the text format.

The system (900) may further include: a voice replaying unit (909), in response to receiving a voice replaying command input from the response outputting unit (907) through the user terminal's browser, notify the second outputting unit (906) and carry out the outputting of the expression information of the target language through the text characters format or voice format.

FIG. 9B illustrates an exemplary structural diagram of the translating unit (902) of FIG. 9A, according to another embodiment of the disclosure. More specifically, FIG. 9B illustrates an exemplary method which accomplishes the function of input language to target language interpretation through the translating unit (902).

As discussed in step S204 of FIG. 2, the input language may be expressed in the form of voice format or expressed in text characters format (i.e., choosing identifier (610) in FIG. 6).

By choosing input in voice format identifier (620) in FIG. 6, spoken voice signal (902-1) of input language (e.g., Chinese) may be received by a voice to text conversion (902A), which the input language (Chinese) voice signal may be first converted into the text characters of the input language (Chinese). The input language text characters may then be translated into the target language (e.g., English) text character by a text to text translator (902B) using a language semantics library. The translated text character may be output (902-3) to the first outputting unit (903) as target language output in text characters format. The translated text character may be output to a text to voice converter (902C), which may convert the target language from text characters format into speech signals to be output to the second outputting unit (904) as target language (English) output in voice format.

Likewise, by choosing input in voice format identifier (610) in FIG. 6, text characters input (902-2) of input language (e.g., Chinese) may be received and directly translated into the target language (e.g., English) text character by a text to text translator (902B) using a language semantics library. The translated text character may be output (902-3) to the first outputting unit (903) as target language output in text characters format. The translated text character may be output to a text to voice converter (902C), which may convert the target language from text characters format into speech signals to be output to the second outputting unit (904) as target language (English) output in voice format.

In another embodiment, steps 204 to 208 may alternately be performed remotely by an application server through an internet connection, which processes received the input language signals (in text characters or voice format) from a user's mobile terminal, and returns the target language information (in text characters or voice format) to the user's mobile terminal.

The method, the system and the mobile terminal, which are disclosed in the embodiments of the present disclosure, for realizing the language interpretation in the browser have been introduced in detail above. It should be understood by those with ordinary skill in the art that all or some of the steps of the foregoing embodiments may be implemented by hardware, or software program codes stored on a non-transitory computer-readable storage medium with computer-executable commands stored within. For example, the disclosure may be implemented as an algorithm as codes stored in a program module or a system with multi-program-modules. The computer-readable storage medium may be, for example, nonvolatile memory such as compact disc, hard drive. ROM or flash memory. The computer-executable commands are used to enable a computer, server, a smart phone, a tablet or any similar computing device to accomplish the language interpretation operations.

The foregoing represents only some preferred embodiments of the present disclosure and their disclosure cannot be construed to limit the present disclosure in any way. Those of ordinary skill in the art will recognize that equivalent embodiments may be created via slight alterations and modifications using the technical content disclosed above without departing from the scope of the technical solution of the present disclosure, and such summary alterations, equivalent has changed and modifications of the foregoing embodiments are to be viewed as being within the scope of the technical solution of the present disclosure.

1. A method for realizing language interpretation through a browser, comprising:
receiving through a user's terminal browser language interpretation interface, expression information of an input language;
translating the expression information of the input language into expression information of a target language, according to an input predetermined conversion relation between the input language and the target language;
outputting the expression information of the target language through a text format; and
outputting the expression information of the target language through a voice format.

2. The method according to claim 1, further comprising:
storing the voice format of the expression information of the target language.

3. The method according to claim 2, wherein the receiving of the expression information of the input language through the user's terminal browser language interpretation interface, comprising one of:
receiving the expression information of the input language through the voice format; or
receiving the expression information of the input language through the text format.

4. The method according to claim 3, wherein before the receiving of the expression information of the input language through the voice format or the text format, further comprising:
receiving an operation command through the user's terminal browser language interpretation interface;
in response to the operation command, outputting the language interpretation interface in the browser;
storing the input predetermined conversion relation between the input language and the target language; and
storing a volume level of the voice format of the expression information of the target language through the language interpretation interface in the browser.

5. The method according to claim 1, comprising outputting of the expression information of the target language through voice format according to a volume level.

6. The method according to claim 1, comprising:
in response to receiving a translation duplication command input through the user terminal's browser, carrying out the translation duplication of the expression information of the target language through the text format.

7. The method according to anyone of claim 1, comprising:
in response to receiving the translation duplication command input through the user terminal's browser, carrying out the outputting of the expression information of the target language through the voice format.

8. A system for realizing a language interpretation through a browser, the system comprises at least a processor operating in conjunction with at least a memory which stores instruction codes operable as a plurality of units, the plurality of units comprise:
a first receiving unit configured to receive through a user's terminal browser language interpretation interface, expression information of an input language;
a translating unit configured to translate the expression information of the input language into expression information of a target language, according to an input predetermined conversion relation between the input language and the target language;
a first outputting unit configured to output the expression information of the target language through a text format; and
a second outputting unit configured to output the expression information of the target language through a voice format.

9. The system according to claim 8, comprises:
a storage unit configured to store the voice format of the expression information of the target language.

10. The system according to claim 9, wherein,
the first receiving unit receives through the voice format, the expression information of the input language through the user's terminal browser language interpretation interface; or
the first receiving unit receives through the text format, the expression information of the input language through the user's terminal browser language interpretation interface.

11. The system according to claim 10, wherein before the receiving of the expression information of the input language through the voice format or the text format:
a second receiving unit configured to receive an operation command through the user's terminal browser language interpretation interface;
a response outputting unit configured to respond to the operation command and output the language interpretation interface in the browser;
the storage unit further configured to store the input predetermined conversion relation between the input language and the target language; and store a volume level of the voice format of the expression information of the target language through the language interpretation interface in the browser.

12. The system according to claim 8, wherein the second outputting unit outputs the expression information of the target language through a voice format according to a volume level.

13. The system according to anyone of claims 8, further comprises:
a response duplicating unit configured to in response to receiving a translation duplication command input through the user terminal's browser, carry out the translation duplication of the expression information of the target language through the text format.

14. The system according to anyone of claims 8, further comprises:
a voice replaying unit configured to in response to receiving the translation duplication command input through the user terminal's browser, carry out the outputting of the expression information of the target language through the voice format.

15. The system according to anyone of claims 8, wherein the system being a mobile terminal

16. A non-transitory computer-readable medium having stored thereon, a computer program having at least one code section being executable by a machine for causing the machine to perform functions, comprising:
receiving through a user's terminal browser language interpretation interface, expression information of an input language;
translating the expression information of the input language into expression information of a target language, according to an input predetermined conversion relation between the input language and the target language;
outputting the expression information of the target language through a text format; and
outputting the expression information of the target language through a voice format.
